(19) United States
(12) Patent Application Publication
(10) Pub. No.: US 2019/0193544 A1
(43) Pub. Date: Jun. 27, 2019

(54) Thermal Protection Cover for a Vehicle

(71) Applicant: Juan Carlos Gallego, Everett, MA (US)

(72) Inventor: Juan Carlos Gallego, Everett, MA (US)

(21) Appl. No.: 16/229,830

(22) Filed: Dec. 21, 2018

Related U.S. Application Data
(60) Provisional application No. 62/610,420, filed on Dec. 26, 2017.

(51) Int. Cl. B60J 11/04; H05B 3/36

(52) U.S. Cl. CPC B60J 11/04; H05B 2203/031; H05B 3/36

(57) ABSTRACT

Disclosed is a thermal protection cover for a vehicle. The cover is comprised of a top layer, a bottom layer, a heating element, and a battery. The heating element is connected to the battery by a connector. The battery is place at one of the corner of the cover in a socket to avoid water deposition in the surrounding area. The heating element is insulated and made up of gauge wire or metal rods and further the heating element is sandwiched between the top layer and the bottom layer of the cover. The heating element runs in a looped configuration which traverses the length and width of the covering and heats the entire cover. Once activated, the temperature of the insulated heating element quickly rises, warms the surface of the cover and efficiently melts accumulated ice or snow. The cover operates on a rechargeable battery source.

### RELATED APPLICATION(S)

Under provisions of 35 U.S.C. § 119, the Applicant(s) claim the benefit of U.S. provisional application No. 62/610,420, filed Dec. 26, 2107, which is incorporated herein by reference.

### FIELD OF THE INVENTION

The invention relates generally to vehicle accessories, and in particular to a thermal protection cover for a vehicle.

### BACKGROUND OF THE INVENTION

Millions of vehicle owners are familiar with the difficulties of protecting their vehicles from cold weather, particularly when there is no garage, carport, or other roofed structure available to protect the vehicle. Cold winter mornings are one of the worst times to have problems getting the vehicle started. Unfortunately, those same cold mornings are also the times when the user is most likely to have trouble. Battery problems in cold weather are common as batteries are vulnerable to the low temperatures. Engine oil could also become a huge problem as in cold weather it becomes thicker and doesn't flow well. Further, the cold weather also affects locks and windshield wipers. Additionally, cleaning snow and ice from the vehicle, particularly on the windshield and rear view mirror, is also one of the time consuming chores for the vehicle owner.

A search of the prior art reveals various devices which have been developed to address this set of problems, or related problems. None are closely related to the present invention, but several include features which resemble those of the present invention. Each has proven to be less than satisfactory for the present purpose in its own way.

Further, U.S. Pat. No. 6,779,827 (priority May 14, 2002) titled “Automobile cover” provides an automobile cover apparatus and system. The automobile cover generally includes a main cover body having a hood end, a trunk end, an upper surface and a lower surface, connectors located on the hood end and the trunk end, trunk cords connected to the connectors on the trunk end, a trunk anchor connected to the trunk cords on ends of the trunk cords opposite the ends connected to the connectors, hood cords connected to the connectors on the hood end and a hood connection device connected to each of the hood cords opposite the ends connected to the connectors. The cover is combinable with a winder for an automobile cover kit. However, the disclosed cover protects the interior of an automobile from heating to high temperatures. It may not protect the automobile from cold weather.

Further, U.S. Pat. No. 2,666,840 (priority Jun. 8, 1951) titled “Heated vehicle cover” provides a vehicle cover comprising a sheet of pliable material having a longitudinal central strip adapted to cover a vehicle top surface from its rear to its front bumper and including side panels having one edge of each secured to an edge of the central strip intermediate its ends. Transverse flexible stays are embedded in the central strip and extend across substantially the entire width thereof as means for securing the central strip to the front and rear bumpers. Flexible stays are resiliently adjustable means for securing the side panels to the sides of a vehicle at spaced points there along. Electrical resistance heaters are embedded in said cover for supplying current to said heaters. However, the disclosed cover needs an external power source connected via a power cord.

Further, U.S. Pat. No. 2,201,984 (priority Jan. 19, 1939) titled “Heated automobile blanket” provides an automobile blanket to keep the radiator of an automobile from freezing when it is standing in a cold garage or exposed to outdoor weather. A means is included for heating the blanket and for supporting the blanket adjacent to said supporting means. Entirely covering an automobile, the blanket consists of an outer fabric member, and an inner fabric member. Said members are spaced apart by pieces of felt which measure approximately one inch in thickness. The inner fabric member has a multiplicity of openings, approximately one inch in diameter and spaced approximately two feet apart to aid in circulating heated air. In front, the blanket is supported in a substantially spaced relation to the inner blanket by a foldable frame. An open space is provided between the outer blanket and inner blanket by reason of the distribution of the spacing felt blocks. The heated air is generated by a heater which may be a gas, oil or electric stove. This heated air circulates from a chamber area into the space between the blankets. The chamber is formed by reason of the supporting frame which holds the outer blanket away from the heater and also substantially away from the inner blanket. However, the disclosed blanket circulates heated air which may make it expensive to manufacture. Further, the heating may be inefficient.

Further, U.S. Pat. No. 6,981,509 (priority Sep. 11, 2003) “Protective cover for a vehicle” provides a protective vehicle cover comprising a sheet or a web of a flexible material that possesses a property of buckling or curving in the upward direction from the vehicle with the formation of a canopy-type shield for protecting the vehicle from direct sun rays, birds' droppings, etc. The sheet has a length exceeding the length of the upper surface periphery of the vehicle so that the upwardly curved canopy is formed either by applying two oppositely directed forces to the opposite ends of the sheet or by prestressing the sheet. The sheet can be made from plastic or a fabric that incorporates springing metal strips that tend to curve upward when they are in a free state. The sheet can be conveniently stored in wound state in a cylindrical cassette. Storage of the flexible material in a wound state enhances the property of bucking or curving when the sheet is withdrawn from the cassette. However, the disclosed sheet may not protect the automobile from cold weather.

However, the above mentioned references and many other similar references has one or more of the following shortcomings: (a) expensive; (b) complex tools; and (c) having higher maintenance costs.

Accordingly, there is a need for an improved automobile cover which protects automobiles from cold weather that may also overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some embodiments, a thermal protection cover for a vehicle is disclosed. The cover is comprised of a top layer, a bottom layer, a heating element, and a battery. The heating element is connected to the battery by a connector. The battery is place at one of the corner of the cover in a socket to avoid water deposition in the surrounding area. The heating element is insulated and sandwiched between the top layer and the bottom layer of the cover. The top layer is made of a water resistant, heat absorbing material to melt any snow accumulated on the top layer. The bottom layer is made of a heat resistant material to protect the car's surface. Similar in function to an electric blanket, the heating element runs in a looped configuration which traverses the length and width of the cover and heats the entire cover. Once activated, the temperature of the insulated heating element quickly rises, which warms the surface of the cover and efficiently melts accumulated ice or snow. The cover operates on a rechargeable battery source.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top view of a cover for a vehicle, in accordance with a first exemplary embodiment.

FIG. 2 is a top front perspective view of the cover of FIG. 1.

FIG. 3 is a top side perspective view of the cover of FIG. 1.

FIG. 4 is an exploded side perspective view of the cover of FIG. 1.

FIG. 5 is an exploded front perspective view of the cover of FIG. 1.

FIG. 6 is a side view of the cover of FIG. 1 placed over a vehicle, in accordance with an exemplary embodiment.

FIG. 7 is a front perspective view of the cover of FIG. 1 placed over the vehicle of FIG. 6.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of covers for automobiles, embodiments of the present disclosure are not limited to use only in this context.

Fortunately, an after-market accessory is available which can be used to prevent the effects of cold weather on a parked vehicle from occurring. A thermal protection cover for a vehicle, which provides a sturdy protective cover which may be rapidly deployed to temporarily cover the vehicle, would resolve this problem.

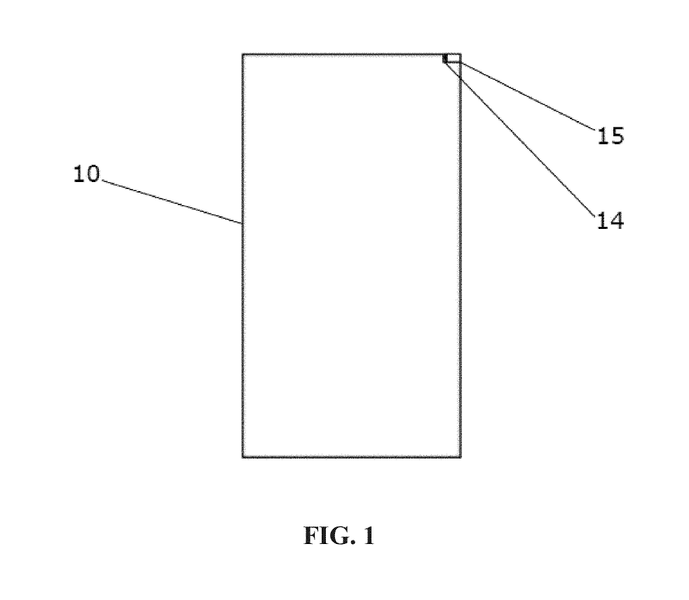

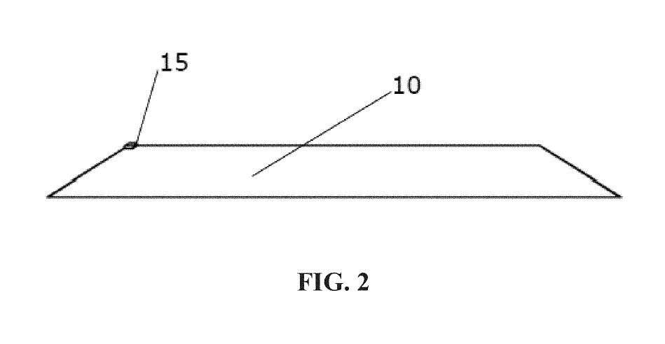

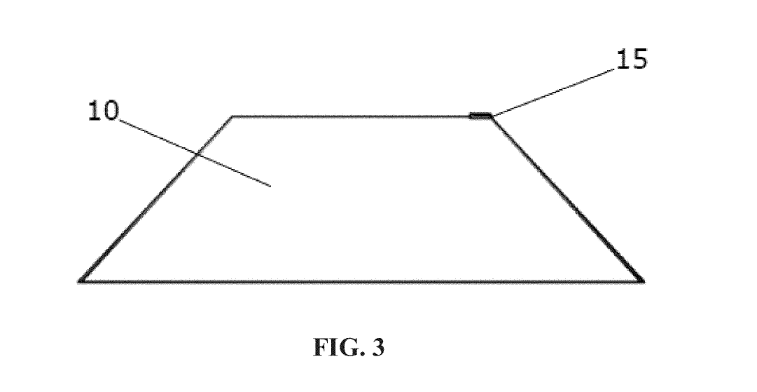

FIG. 1 is a top view of a cover 10 for a vehicle, in accordance with a first exemplary embodiment. The cover 10 includes a connector 14, and a battery 15. FIG. 2 is a top front perspective view of the cover 10. FIG. 3 is a top side perspective view of the cover 10.

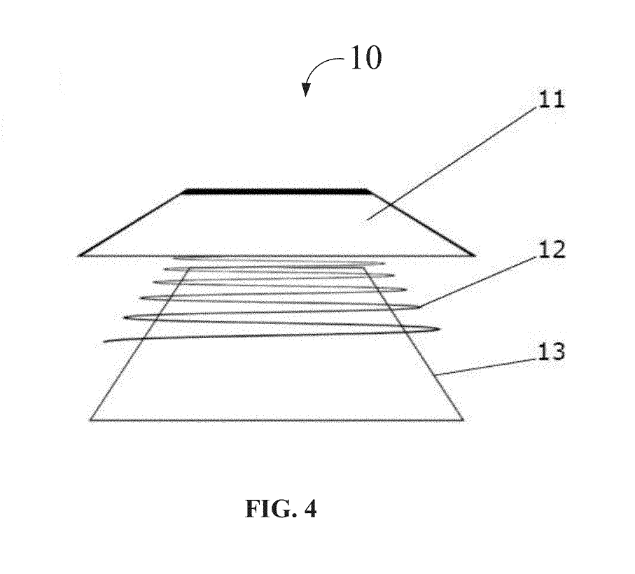

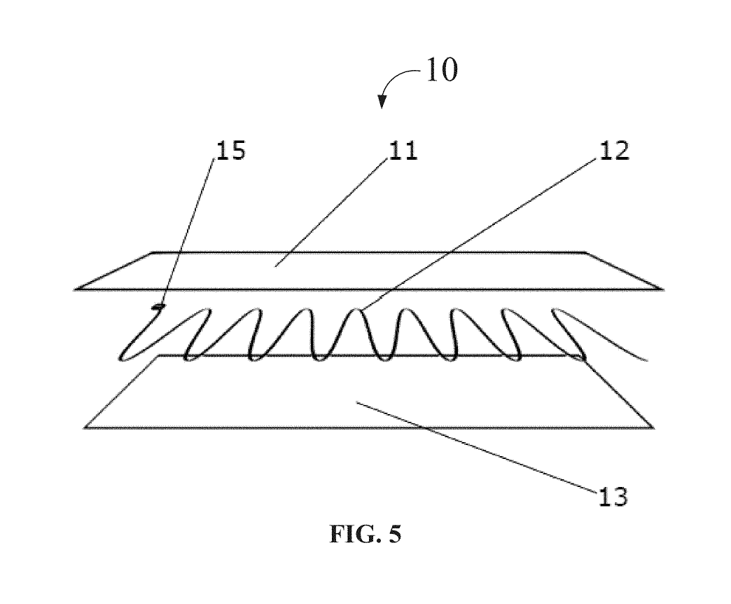

FIG. 4 is an exploded side perspective view of the cover 10. The cover 100 includes a top layer 11, a heating element 12, and a bottom layer 13. FIG. 5 is an exploded front perspective view of the cover 10.

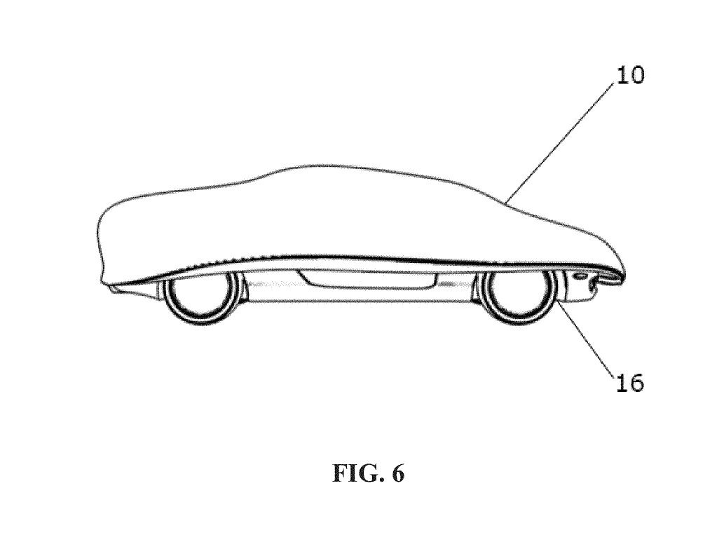

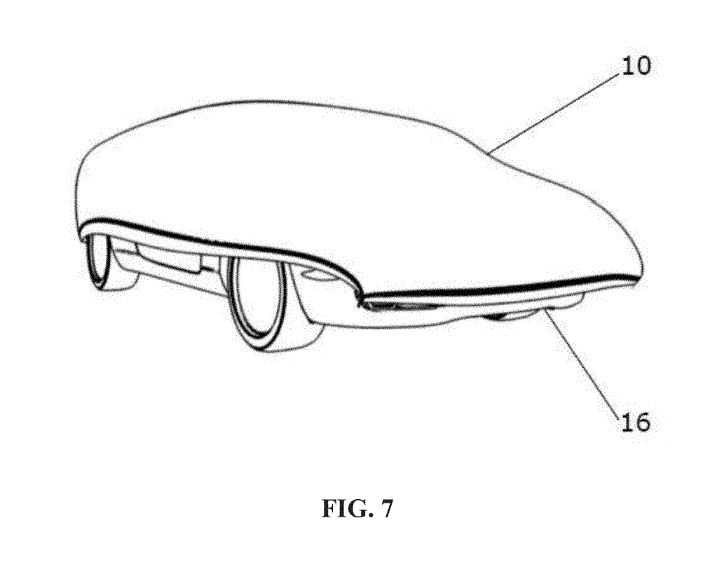

FIG. 6 is a side view of the cover of 10 placed over a vehicle 16, in accordance with an exemplary embodiment. FIG. 7 is a front perspective view of the cover 10 placed over the vehicle of 16.

According to some embodiments, the cover 10 is intended for use as an after-market modification for the user's vehicle, to be purchased and installed by the user. Alternate embodiments, which may be installed as original equipment by the manufacturer of the vehicle, are contemplated.

According to the first exemplary embodiment, the thermal cover 10 is comprised of a top layer 11, a bottom layer 13, a heating element 12, and a battery 15. The heating element 12 is connected to the battery 15 by a connector 14. The battery 15 is positioned at one of the corners of the thermal cover 10 in a socket to avoid water deposition in the surrounding area. The heating element 12 is insulated and made up of gauge wire or metal rods and further the heating element 12 is sandwiched between the top layer 11 and the bottom layer 13 of the thermal cover 10.

The top layer 11 is made of a water resistant, heat absorbing material to melt any accumulated snow or ice. The bottom layer 13 is made of a heat resistant material to protect the car's surface. According to an embodiment, the heating element 12 runs in a looped configuration which traverses the length and width of the covering and heats the entire covering. Once activated, the temperature of the insulated heating element 12 quickly rises, which warms the surface of the thermal cover 10 and efficiently melts accumulated ice or snow.

The thermal cover 10 receives power from a rechargeable battery 15. The battery 15 includes a power switch to turn-on or turn-off the heating element 12. The battery 15 may be any one of several different varieties which may be connected with a standard wall outlet. The battery 15 may be produced in many different shapes and sizes. Several different combinations of electrode materials and electrolytes are used, including lead-acid, nickel-cadmium (NiCd), nickel-metal hydride (NiMH), lithium-ion (Li-ion), and lithium-ion polymer (Li-ion polymer).

Further, in an alternate arrangement the thermal cover 10 may also include a solar panel which may recharge the battery 15. In another alternate arrangement the thermal cover 10 for covering a motor vehicle may also include a snow sensor, which may activate the heating element 12 whenever it senses the snow.

To use the cover 10, the user opens and unrolls the cover 10 over the top surface of the user's vehicle 16. For example, the user may use the cover 10 upon the approach of a snowstorm. The user then unfolds the cover 10 such that the entire vehicle 16 is covered.

The top layer 11 and the bottom layer 13 are preferably manufactured from a flexible, durable material with substantial heat resistant properties, such as canvas or sailcloth. The heating element 12 is preferably manufactured from an electrically conductive carbon carrying fabric coated with a soft stabilizing material. The connector 14 and the battery 15 are preferably manufactured from rigid, durable, corrosion resistant materials with substantial structural strength, such as steel, copper alloy, and aluminum alloy. Components and methods listed above are preferable, but artisans will recognize that alternate components and methods could be selected without altering the scope of the invention.

Although the invention has been explained in relation to its preferred embodiment, it is to be understood that many other possible modifications and variations can be made without departing from the spirit and scope of the invention.

What is claimed is:

1. A thermal protection cover for a vehicle, comprised of a top layer, a bottom layer, a flexible heating element, and a battery which is connected to the heating element by a connector.

2. The thermal cover of claim 1, wherein the battery is positioned at one of the corners of the thermal cover in a socket to avoid water deposition in the surrounding area.

3. The thermal cover of claim 1, wherein the heating element is insulated and sandwiched between the top layer and the bottom layer of the thermal cover 10.

4. The thermal cover of claim 1, wherein the top layer is a water resistant, heat absorbing material to melt frozen accumulation and the bottom layer is a heat resistant material to protect the car's surface.

5. The thermal cover of claim 1, wherein the heating element runs in a looped configuration which traverses the length and width of the covering and heats the entire thermal cover.

6. The thermal cover of claim 1, wherein once activated, the temperature of the insulated heating element quickly rises, warms the surface of the thermal cover, and efficiently melts accumulated ice or snow.

7. The thermal cover of claim 1, wherein the thermal cover operates on a rechargeable battery which provides a power switch to turn on or turn off the heating element.

8. The thermal cover of claim 1, wherein the battery can be any one of several different varieties which may be connected with a standard wall outlet.

9. The thermal cover of claim 1, wherein the user opens and unrolls the cover over the top surface of the user's vehicle upon the approach of a snowstorm, then unfolds the cover such that the entire vehicle is covered.

10. The thermal cover of claim 1, wherein the top layer and the bottom layer are preferably manufactured from a flexible, durable material with substantial heat resistant properties, such as canvas or sailcloth.

11. The thermal cover of claim 1, wherein the heating element is preferably manufactured from an electrically conductive carbon carrying fabric coated with a soft stabilizing material.

12. The thermal cover of claim 1, wherein the connector and the battery are preferably manufactured from rigid, durable, corrosion resistant materials with substantial structural strength, such as steel, copper alloy, and aluminum alloy.
